(19) United States
(12) Patent Application Publication
(10) Pub. No.: US 2015/0105256 A1
(43) Pub. Date: Apr. 16, 2015

(54) AQUEOUS HERBICIDAL CONCENTRATES

(71) Applicant: DOW AGROSCIENCES LLC, Indianapolis, IN (US)

(72) Inventor: Mei Li, Westfield, IN (US)

(73) Assignee: DOW AGROSCIENCES LLC, Indianapolis, IN (US)

(21) Appl. No.: 14/511,281

(22) Filed: Oct. 10, 2014

Related U.S. Application Data
(60) Provisional application No. 61/889,801, filed on Oct. 11, 2013.

(51) Int. Cl. A01N 25/02; A01N 37/38; A01N 43/40

(52) U.S. Cl. CPC A01N 25/02; A01N 43/40; A01N 37/38
USPC 504/130

(57) ABSTRACT

Aqueous based pesticide compositions having a high concentration of a water-soluble salt of 2,4-dichlorophenoxyacetic acid (2,4-D) and a lower concentration of a water-insoluble herbicide (halauxifen-methyl and/or fluoroxypyr-meptyl) are provided herein. These compositions are, among other things, transparent, homogeneous, stable upon storage in various thermal environments, and upon dilution in water form a stable emulsion.

### I. CROSS REFERENCE TO RELATED APPLICATIONS

This application claims the benefit of U.S. Provisional Patent Application Ser. No. 61/889,801 filed Oct. 11, 2013.

### II. BACKGROUND

High-strength, e.g., high concentration or high-load, pesticidal formulations are desirable for a variety of economic and environmental reasons, including the reduction of shipping and handling costs. Liquid, pre-mix concentrates containing two or more pesticidal active ingredients are useful in a wide variety of agricultural applications. For example, two or more pesticidal active ingredients may be combined in order to control a wider spectrum of pests, or to utilize multiple modes of action, compared to the individual active ingredients alone.

Normally, water insoluble pesticide active ingredients are formulated in water with water soluble pesticides as aqueous suspension concentrates (SC) or by dissolving the water insoluble pesticide in an organic solvent and forming an oil-in-water emulsion (EW). The preparation of these liquid, pre-mix concentrates can be challenging owing to chemical and/or physical instability. Examples of physical instability with these compositions include, for example, phase separation, crystallization, settling, sedimentation, gelling, and agglomeration.

Water soluble salts of pesticides, e.g., glyphosate salts, when dissolved in water form high ionic strength solutions that when combined with organic solutions containing oil-soluble pesticides normally form oil-in-water emulsions. These pre-mix, concentrate compositions, however, can be difficult to stabilize owing to the high ionic strength of the aqueous phase and require the proper choice of surfactants and/or additional inert ingredients. Previous efforts to combine oil soluble herbicides with aqueous solutions containing salts of glyphosate in a liquid concentrate formulation have been disclosed, for example, in U.S. Pat. No. 6,713,433 B2, U.S. Pat. No. 6,689,719 and U.S. Pat. No. 6,369,001.

### III. SUMMARY

Provided herein are stable aqueous herbicidal compositions comprising:
a) a water soluble salt of 2,4-D comprising, with respect to the total composition, from about 200 gram acid equivalent per liter (g ae/L) to about 550 g ae/L of 2,4-D;
b) a second herbicide comprising, with respect to the total composition, from about 0.1 g ae/L to about 20 g ae/L of halauxifen-methyl, from about 20 g ae/L to about 150 g ae/L of fluoroxypyr-meptyl, or a mixture thereof;
c) from about 0 g/L to about 150 g/L, with respect to the total composition, of at least one of an ionic and/or a non-ionic surfactant;
d) from about 10 g/L to about 500 g/L, with respect to the total composition, of a water immiscible organic solvent; and
e) from about 200 g/L to about 800 g/L, with respect to the total composition, of water;
   wherein the composition forms a stable, transparent, and homogenous herbicidal composition.

Also provided herein is a method of controlling undesirable vegetation comprising contacting the vegetation or an area adjacent thereto to prevent the emergence of growth of vegetation a herbicidally effective amount of a herbicidal composition comprising:
a) a water soluble salt of 2,4-D comprising, with respect to the total composition, from about 200 g ae/L to about 550 g ae/L of 2,4-D;
b) a second herbicide comprising, with respect to the total composition, from about 0.1 g ae/L to about 20 g ae/L of halauxifen-methyl, from about 20 g ae/L to about 150 g ae/L of fluoroxypyr-meptyl, or a mixture thereof;
c) from about 0 g/L to about 150 g/L, with respect to the total composition, of at least one of an ionic and/or a non-ionic surfactant;
d) from about 10 g/L to about 500 g/L, with respect to the total composition, of an organic solvent; and
e) an aqueous phase comprising, with respect to the total composition, from about 200 g/L to about 800 g/L of water;
   wherein the composition forms a stable, transparent, and homogenous herbicidal composition.

### IV. DETAILED DESCRIPTION

The inventors herein have surprisingly found that combining an aqueous concentrate of a water soluble salt of 2,4-D with a water insoluble second herbicide dissolved in a water immiscible organic solvent, provides a stable, transparent, and homogenous herbicidal composition that exhibits good high and low temperature storage stability even in the absence of any surfactants and readily forms a stable emulsion upon dilution into a spray solution of water.

Provided herein are stable aqueous herbicidal compositions comprising:
a) a water soluble salt of 2,4-D comprising, with respect to the total composition, from about 200 gram acid equivalent per liter (g ae/L) to about 550 g ae/L of 2,4-D;
b) a second herbicide comprising, with respect to the total composition, from about 0.1 g ae/L to about 20 ae/L of halauxifen-methyl and/or from about 20 g ae/L to about 150 g ae/L of fluoroxypyr-meptyl;
c) from about 0 g/L to about 150 g/L of at least one of an ionic and a non-ionic surfactant;
d) from about 10 g/L to about 500 g/L, with respect to the total composition, of a water immiscible organic solvent; and
e) from about 200 g/L to about 800 g/L, with respect to the total composition, of water;
   wherein the composition forms a stable, transparent, and homogenous herbicidal composition. These compositions also show no visible phase separation after storage at 54° C. for 2 weeks and/or no crystal formation after −10/40° C. freeze/thaw cycling conditions every 24 hours for 2 weeks.

In certain embodiments, the described compositions optionally include additional active ingredients and/or inert formulation ingredients.

In certain embodiments, the described aqueous herbicide compositions form stable emulsions upon dilution into a spray solution containing water.

Also provided herein is a method of controlling undesirable vegetation comprising contacting the vegetation or an area adjacent thereto to prevent the emergence of growth of vegetation a herbicidally effective amount of a herbicidal composition comprising:
a) a water soluble salt of 2,4-D comprising, with respect to the total composition, from about 200 g ae/L to about 550 g ae/L of 2,4-D;
b) a second herbicide comprising, with respect to the total composition, from about 0.1 g ae/L to about 20 g ae/L of halauxifen-methyl and/or from about 20 g ae/L to about 150 g ae/L of fluoroxypyr-meptyl;
c) from about 0 g/L to about 150 g/L, with respect to the total composition, of at least one of an ionic and/or a non-ionic surfactant;
d) from about 10 g/L to about 500 g/L, with respect to the total composition, of an organic solvent; and
e) an aqueous phase comprising, with respect to the total composition, from about 200 g/L to about 800 g/L of water;
   wherein the composition forms a stable, transparent, and homogenous herbicidal composition.

A. 2,4-D Water Soluble Salts

The term “water-soluble” in relation to a herbicide or a salt thereof as used herein means having solubility in deionized water at 20° C. sufficient to enable the water-soluble active ingredient to be dissolved completely in the aqueous phase of a composition at the desired concentration. In some embodiments, the water-soluble active ingredients useful in the compositions described herein have solubility in deionized water at 20° C. of not less than about 50 g/L or not less than about 200 g/L.

The water-soluble salts of 2,4-D (2,4-dichlorophenoxyacetic acid) contained in the aqueous compositions described herein include, e.g., salts containing one or more cations selected from the class of organo ammonium cations, wherein the organo ammonium cations may have from 1 to about 10 carbon atoms. Exemplary organo ammonium cations include, for example, isopropyl ammonium, dimethyl ammonium, diethyl ammonium, triethyl ammonium, dimethylethanol ammonium, diethanol ammonium, triethanol ammonium, triisopropanol ammonium, tetramethyl ammonium, and N,N,N-trimethylethanol ammonium (choline). In certain embodiments, the water-soluble salt of 2,4-D is 2,4-D dimethyl ammonium or 2,4-D N,N,N-trimethylethanol ammonium (choline).

The described aqueous compositions comprise, with respect to the total composition, from about 200 gram acid equivalent per liter (g ae/L) to about 550 g ae/L of at least one dissolved 2,4-D salt, e.g., 2,4-D dimethyl ammonium or 2,4-D choline. The water-soluble herbicide active ingredient of the compositions described herein, e.g., the herbicide 2,4-D dimethyl ammonium or 2,4-D choline, are present at a concentration in the composition as a whole sufficient, upon dilution of the composition in a suitable volume of water and applied by spraying to the target locus, to be herbicidally effective. In some embodiments, the described compositions comprise from about 200 to about 550 g ae/L, from about 200 to about 450 g ae/L, from about 200 to about 350 g ae/L, from about 200 to about 300 g ae/L, from about 200 to about 280 g ae/L or from about 220 to about 260 g ae/L of 2,4-D dimethyl ammonium and/or 2,4-D choline. In certain embodiments, the described compositions comprise from about 250 to about 550 g ae/L, from about 300 to about 550 g ae/L, from about 300 to about 525 g ae/L, from about 350 to about 525 g ae/L, from about 400 to about 525 g ae/L, from about 450 to about 525 g ae/L, from about 480 to about 510 g ae/L, from about 350 to about 500 g ae/L, from about 340 to about 450 g ae/L, from about 340 to about 400 g ae/L, from about 340 to about 380 g ae/L, from about 300 to about 400 g ae/L, from about 300 to about 380 g ae/L, from about 300 to about 360 g ae/L, from about 310 to about 350 g ae/L, or from about 320 to about 340 g ae/L of 2,4-D dimethyl ammonium and/or 2,4-D choline.

B. Second Herbicide

As used herein, halauxifen-methyl, also known as Arylex™ Active (trademark of Dow AgroSciences, LLC), is methyl 4-amino-3-chloro-6-(4-chloro-2-fluoro-3-methoxyphenyl)pyridine-2-carboxylate and has the following structure:

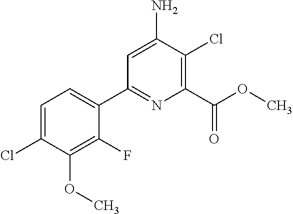 [SMILES: COC(=O)c1nc(-c2ccc(Cl)c(OC)c2F)cc(N)c1Cl]

Halauxifen-methyl provides post-emergence control of some broad-leaved weeds.

As used herein, fluoroxypyr-meptyl, also known as fluoroxypyr-MHE, is 1-methylheptyl [(4-amino-3,5-dichloro-6-fluoropyridin-2-yl)oxy]acetate and has the following structure:

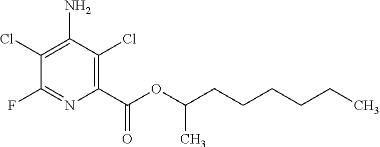 [SMILES: CCCCCCC(C)OC(=O)c1nc(F)c(Cl)c(N)c1Cl]

Fluoroxypyr-meptyl's herbicidal activity is exemplified in The Pesticide Manual, Fifteenth Edition, 2009. Fluoroxypyr-meptyl has a melting point of about 58° C. and provides post-emergence control of some broad-leaved weeds.

In some embodiments, the described compositions comprise from about 0.1 g acid equivalent (ae)/L to about 20 g ae/L, from about 0.1 g ae/L to about 15 g ae/L, from about 0.1 g ae/L to about 10 g ae/L, from about 0.5 g ae/L to about 10 g ae/L, from about 1 g ae/L to about 10 g ae/L, from about 1 g ae/L to about 8 g ae/L, from about 1 g ae/L to about 7 g ae/L, from about 1 g ae/L to about 5 g ae/L, from about 1 g ae/L to about 4 g ae/L, from about 1 g ae/L to about 3 g ae/L, from about 2 g ae/L to about 6 g ae/L, from about 3 g ae/L to about 6 g ae/L, from about 4 g ae/L to about 6 g ae/L, from about 2 g ae/L to about 5 g ae/L or from about 2 g ae/L to about 4 g ae/L of halauxifen-methyl.

In some embodiments, the described compositions comprise from about 20 g ae/L to about 150 g ae/L, from about 30 g ae/L to about 150 g ae/L, from about 40 g ae/L to about 150 g ae/L, from about 40 g ae/L to about 130 g ae/L, from about 50 g ae/L to about 120 g ae/L, from about 60 g ae/L to about 120 g ae/L, from about 70 g ae/L to about 120 g ae/L, from about 20 g ae/L to about 120 g ae/L, from about 20 g ae/L to about 100 g ae/L, from about 20 g ae/L to about 90 g ae/L, from about 20 g ae/L to about 80 g ae/L, from about 20 g ae/L to about 70 g ae/L, from about 20 g ae/L to about 60 g ae/L, from about 20 g ae/L to about 50 g ae/L, from about 30 g ae/L to about 40 g ae/L, from about 30 g ae/L to about 90 g ae/L, from about 40 g ae/L to about 90 g ae/L, from about 50 g ae/L to about 90 g ae/L, from about 60 g ae/L to about 90 g ae/L, or from about 70 g ae/L to about 85 g ae/L of fluoroxypyr-meptyl.

In certain embodiments, the second herbicide for use in the described compositions is a combination of both fluoroxypyr-meptyl and halauxifen-methyl. When combined, the weight ratio, on an ae basis, of the 2,4-D organo ammonium salt to halauxifen-methyl in the described compositions ranges from about 5500:1 to about 10:1, from about 2500:1 to about 10:1, from about 1500:1 to about 10:1, from about 500:1 to about 10:1, from about 400:1 to about 10:1, from about 300:1 to about 10:1, from about 200:1 to about 10:1, from about 150:1 to about 10:1, from about 125:1 to about 10:1, from about 100:1 to about 10:1, from about 75:1 to about 10:1, from about 50:1 to about 10:1, from about 25:1 to about 10:1, or from about 15:1 to about 10:1. In some embodiments the weight ratio, on an ae basis, of the 2,4-D organo ammonium salt to fluoroxypyr-meptyl in the described compositions may range from about 30:1 to about 1:1, from about 25:1 to about 1:1, from about 20:1 to about 1:1, from about 15:1 to about 1:1, from about 10:1 to about 1:1, from about 8:1 to about 1:1, from about 7:1 to about 1:1, from about 6:1 to about 1:1, from about 5:1 to about 1:1, from about 4:1 to about 1:1, from about 3:1 to about 1:1, or from about 2:1 to about 1:1.

C. Surfactants

In some embodiments, the compositions described herein may include one or more surfactants. In some embodiments, the compositions described herein may not include a surfactant. Surfactants useful with the methods and compositions described herein include ionic and/or nonionic surfactants such as, for example, phosphate ester surfactants, polymeric surfactants, or mixtures thereof. Examples of polymeric surfactants include AB or ABA block copolymers; block or graft acrylate or methacrylate copolymers; and alkyd polyethylene oxide resins. Suitable polymeric surfactants include: (1) AB block copolymers that contain EO and PO blocks such as ethylene oxide-propylene oxide (EO-PO) block copolymers, and (2) ABA block copolymers having a hydrophilic portion of polyethylene oxide and a hydrophobic portion of poly(12-hydroxystearate). Examples of suitable phosphate ester surfactants include: (1) acids or salts of mono and dialkyl phosphate esters, (2) acids or salts of ethoxylated mono and dialkyl phosphate esters, (3) acids or salts of mono and dialkyl phosphate esters of ethoxylated tristyrylphenol, (4) acids or salts of mono and dialkyl phosphate esters of ethoxylated phenol and ethoxylated alkylphenols, and mixtures thereof.

In some embodiments the ionic and/or nonionic surfactant is Atlox™ 4912 (Croda; Edison, N.J.), and/or Termul™ 2510 (Huntsman International LLC; The Woodlands, Tex.), and/or Atlox™ DP 13/6.

In some embodiments, the described compositions comprise, with respect to the total composition, from about 0 g/L to about 150 g/L, from about 0 g/L to about 125 g/L, from about 0 g/L to about 100 g/L, from about 0 g/L to about 75 g/L, from about 0 g/L to about 50 g/L, from about 0 g/L to about 40 g/L, from about 0 g/L to about 30 g/L, from about 0 g/L to about 20 g/L, from about 0 g/L to about 10 g/L, from about 0 g/L to about 5 g/L, or from about 0 g/L to about 3 g/L of one or more surfactants. In certain embodiments, the described compositions comprise from about 10 g/L to about 100 g/L, from about 10 g/L to about 90 g/L, from about 10 g/L to about 80 g/L, from about 10 g/L to about 70 g/L, from about 10 g/L to about 60 g/L, from about 10 g/L to about 50 g/L, from about 20 g/L to about 50 g/L, from about 20 g/L to about 40 g/L, or from about 20 g/L to about 30 g/L of one or more surfactants.

D. Water Immiscible Organic Solvent

In certain embodiments, the described compositions include a water immiscible organic solvent. A “water immiscible organic solvent” as defined herein means an organic solvent that when mixed with an equivalent volume of water forms two discrete liquid layers. Examples of organic solvents useful with the methods and compositions described herein include fatty acid amides such as, e.g., N,N-dimethylcaprylamide (N,N-dimethyloctanamide), N,N-dimethylcapramide (N,N-dimethyldecanamide), and mixtures thereof, which are available commercially as Agnique® AMD 810 and Agnique® AMD 10 from BASF-Cognis (Cincinnati, Ohio), Genagen® 4166, Genagen® 4231 and Genagen® 4296 from Clariant (Charlotte, N.C.), Hallcomid M-8-10 and Hallcomid M-10 from Stepan (Northfield, Ill.), Amid DM10 and DM810 from AkzoNobel (Chicago, Ill.), and the morpholine amides of caprylic/capric fatty acids (C₈/C₁₀) which are commercially available as JEFFSOL® AG-1730 Solvent from Huntsman International LLC (The Woodlands, Tex.).

In some embodiments, the compositions described herein comprise from about 10 g/L to about 500 g/L, from about 10 g/L to about 450 g/L, from about 10 g/L to about 400 g/L, from about 10 g/L to about 350 g/L, from about 10 g/L to about 300 g/L, from about 10 g/L to about 250 g/L, from about 10 g/L to about 200 g/L, from about 10 g/L to about 150 g/L, from about 10 g/L to about 100 g/L, from about 10 g/L to about 80 g/L, from about 10 g/L to about 70 g/L, from about 20 g/L to about 70 g/L, from about 30 g/L to about 60 g/L, from about 30 g/L to about 50 g/L, or from about 35 g/L to about 45 g/L of an organic solvent. In some embodiments, the compositions described herein comprise from about 50 g/L to about 450 g/L, from about 75 g/L to about 400 g/L, from about 100 g/L to about 400 g/L, from about 125 g/L to about 375 g/L, from about 150 g/L to about 350 g/L, from about 170 g/L to about 330 g/L, from about 170 g/L to about 300 g/L, from about 170 g/L to about 275 g/L, from about 170 g/L to about 250 g/L, from about 170 g/L to about 230 g/L, from about 180 g/L to about 230 g/L, from about 190 g/L to about 230 g/L, from about 200 g/L to about 230 g/L, or from about 210 g/L to about 230 g/L of a water immiscible organic solvent.

E. Water

The compositions described herein comprise from about 200 g/L to about 800 g/L of water. The water serves as both an aqueous solvent and a carrier for the ingredients in the described compositions. In some embodiments, the compositions described herein comprise from about 200 g/L to about 700 g/L, from about 200 g/L to about 600 g/L, from about 200 g/L to about 500 g/L, from about 200 g/L to about 400 g/L, from about 250 g/L to about 400 g/L, from about 275 g/L to about 400 g/L, from about 300 g/L to about 400 g/L, from about 325 g/L to about 400 g/L, or from about 325 g/L to about 375 g/L of water.

F. Storage Stability

As used herein, “stable” compositions are compositions that are stable physically and/or chemically for defined periods of time to the environments in which they are produced, transported and/or stored. Aspects of stable compositions include, but are not limited to: physical stability at temperatures that range from about 0° C. to about 50° C., homogeneity, pourability, liquids that form little or no precipitated solids or exhibit little or no phase separation, compositions that readily dissolve or disperse when poured into a spray tank of water and retain their biological efficacy when applied, for example, by spray application to target pests. In some embodiments, the described compositions form stable, homogeneous concentrates that do not exhibit phase separations under the storage conditions. In some embodiments, the described compositions exhibit very little change in viscosity under the storage conditions. In some embodiments, the described compositions exhibit very little chemical decomposition of the active ingredients under the storage conditions.

As used herein, the term “transparent, homogenous herbicidal composition” means compositions that pass light through with clarity. Stated another way, the transparent, homogeneous herbicidal compositions are visually clear to the naked eye.

In some embodiments, the described compositions are stable at temperatures of greater than or equal to about 40° C. for a period of at least 4, 6 or 8 weeks. In some embodiments, the described compositions are stable at temperatures greater than or equal to about 54° C. for a period of at least about 2 weeks. In some embodiments, the described compositions do not exhibit or do not significantly exhibit separation or precipitation (or crystallization) of any of the components at elevated temperatures.

In some embodiments, the described compositions remain as homogeneous concentrates for at least about 2 weeks at temperatures below about 20° C., below about 10° C., or equal to or less than about 5° C., or about 0° C. In certain embodiments, the compositions are stable at these temperatures for at least about 2, 4, 6, or 8 weeks.

In some embodiments, the described compositions remain as homogeneous concentrates after subjecting them to freeze/thaw (F/T) conditions for at least about 2 weeks where the temperature is cycled from about −10° C. to about 40° C. every 24 hours.

G. Optional Ingredients

The compositions disclosed herein may optionally contain inert formulation ingredients such as, but not limited to, dispersants, surfactants and wetting agents. These optional inert ingredients may include surfactants conventionally used in the art of formulation that are described, inter alia, in “McCutcheon's Detergents and Emulsifiers Annual,” MC Publishing Corp., Ridgewood, N.J., 1998 and in the “Encyclopedia of Surfactants,” Vol. I-III, Chemical Publishing Co., New York, 1980-81. These surface-active agents can be anionic, cationic or nonionic in character and can be employed as emulsifying agents, wetting agents, suspending agents, or for other purposes.

In addition to the specific methods and compositions set forth above, the methods and compositions described herein also may include compositions containing one or more additional compatible ingredients. These additional ingredients may include, for example, one or more pesticides or other ingredients, which may be dissolved or dispersed in the composition and may be selected from acaricides, algicides, antifeedants, avicides, bactericides, bird repellents, chemosterilants, defoliants, desiccants, disinfectants, fungicides, herbicide safeners, herbicides, insect attractants, insecticides, insect repellents, mammal repellents, mating disrupters, molluscicides, nematicides, plant activators, plant growth regulators, rodenticides, semiochemicals, synergists, and virucides. Also, any other additional ingredients providing functional utility such as, for example, antifoam agents, antimicrobial agents, buffers, corrosion inhibitors, dispersing agents, dyes, fragrants, freezing point depressants, neutralizing agents, odorants, penetration aids, sequestering agents, spray drift control agents, spreading agents, stabilizers, sticking agents, viscosity-modifying additives, water soluble solvents and the like, may be included in these compositions.

When the described compositions are used in combination with an additional active ingredients such as, for example, herbicide active ingredients, the compositions described herein can be formulated with the other active ingredient or active ingredients as premix concentrates, tank-mixed in water with the other active ingredient or active ingredients for spray application or applied sequentially with the other active ingredient or active ingredients in separate spray applications.

H. Methods of Preparation and Use In some embodiments, the compositions described herein are prepared by the steps of:

(1) preparing a solution of the second herbicide in the organic solvent and, optionally, including a surfactant;

(2) adding the solution prepared in step (1) to a concentrated solution of a 2,4-D organo ammonium salt in water with good mixing to form a transparent, homogenous herbicidal composition; and

(3) optionally, adding any additional compatible active or inert ingredients.

Exemplary compatible ingredients that may be added to the described compositions include, but are not limited to, water soluble or water insoluble dispersing surfactants, water insoluble active ingredients and optionally, other inert ingredients such as pH buffers, wetting agents, antifreeze agents, antifoam agents, biocides, etc.

The aqueous herbicidal compositions described herein may optionally be diluted in an aqueous spray mixture for agricultural application such as for weed control in crop fields or in turf. Such compositions are typically diluted with an inert carrier, such as water, before application. The diluted compositions, which are usually applied, for example, to weeds, the locus of weeds or the locus of where weeds may eventually emerge, in some embodiments contain about 0.0001 to about 1 weight percent active ingredient or from 0.001 to about 0.05 weight percent of active ingredient. The present compositions can be applied, for example, to weeds or their locus by the use of conventional ground or aerial sprayers, by addition to irrigation water and by other conventional means known to those skilled in the art.

The compositions and methods described herein may be used in controlling undesirable vegetation in crops possessing single, multiple or stacked genomic traits conferring tolerance to one or more herbicide chemistries and/or inhibitors with single or multiple modes of action.

### EXAMPLES

The following Examples are presented to illustrate various aspects of the compositions described herein and should not be construed as limitations to the claims.

### Example 1

### 2,4-D choline salt aqueous concentrate

A 2,4-D choline salt aqueous concentrate solution was prepared by reacting 2,4-D acid technical with an equimolar amount of choline hydroxide in water at ambient temperature. Additional water was then added, if needed, to reach a target 2,4-D acid equivalent (ae) concentration of 45.7 wt %.

### Example 2

### Halauxifen-methyl and fluoroxypyr-MHE concentrate in Genagen 4166 solvent

A halauxifen-methyl/fluoroxypyr-MHE concentrate solution in Genagen 4166 solvent was prepared by dissolving halauxifen-methyl (2.25 active ingredient (ai) wt %) and fluoroxypyr-MHE (48.36 ai wt %) in Genagen 4166 (49.39 wt %) with mixing until a clear solution was obtained at ambient temperature.

### Example 3

### Herbicidal aqueous composition of 2,4-D choline, halauxifen-methyl and fluoroxypyr-meptyl

The halauxifen-methyl/fluoroxypyr-MHE concentrate solution (Example 2, 13.33 g), additional Genagen 4166 (12.42 g), Atlox 4912 (0.25 g), and Atlox DP 13/6 (2.0 g) were mixed together to provide a homogeneous organic phase, to which the 2,4-D choline aqueous concentrate (Example 1, 72.0 g) was added. Upon mild hand mixing, a transparent, homogenous herbicidal composition was formed with a pH of 7.05 that remained as a transparent, homogenous herbicidal composition without any crystal formation/growth or phase separation after: (1) 2 weeks of storage at freeze-thaw (F/T) conditions (−10° C./40° C. cycle every 24 hours), and (2) 2 weeks of storage at 54° C. The active ingredients in the composition were found to be chemically stable as evidenced by >95% retention of the halauxifen-methyl, fluoroxypyr-MHE and 2,4-D after 2 weeks of storage at 54° C. The melting point of the sample was less than −20° C. according to differential scanning calorimetry (DSC) measurement. Diluting a 1% sample of this solution in 342 ppm hardness water resulted in the formation of an opaque, oil-in-water emulsion.

### Example 4

### Herbicidal aqueous composition of 2,4-D choline, halauxifen-methyl and fluoroxypyr-meptyl

The halauxifen-methyl/fluoroxypyr-MHE concentrate solution (Example 2, 13.33 g) and additional Genagen 4166 (14.67 g) were mixed together to provide a homogeneous organic phase, to which the 2,4-D choline aqueous concentrate (example 1, 72.0 g) was added. Upon mild hand mixing, a transparent, homogenous herbicidal composition was formed with a pH of 7.3 that remained as a transparent, homogenous herbicidal composition without any crystal formation/growth or phase separation after: (1) 2 weeks storage at freeze-thaw (F/T) conditions (−10° C./40° C. cycle every 24 hours), and (2) storage at 54° C. for 2 weeks. Diluting a 5% sample of this solution in 342 ppm hardness water resulted in the formation of an opaque, oil-in-water emulsion. The droplet size of the emulsion was analyzed using a Mastersizer 2000 (Malvern Instruments, UK) and found to be 3.0 microns (D₅₀). The emulsion was free of cream or oil formation after 24 hours at ambient temperature.

The present invention is not limited in scope by the embodiments disclosed herein which are intended as illustrations of a few aspects of the invention and any embodiments which are functionally equivalent are within the scope of this invention. Various modifications of the processes, methods, and compositions in addition to those shown and described herein will become apparent to those skilled in the art and are intended to fall within the scope of the appended claims. Further, while only certain representative combinations of the process and method steps and composition components disclosed herein are specifically discussed in the embodiments above, other combinations of the composition components and process and method steps will become apparent to those skilled in the art and also are intended to fall within the scope of the appended claims. Thus a combination of components or steps may be explicitly mentioned herein; however, other combinations of components and steps are included, even though not explicitly stated. The term comprising and variations thereof as used herein is used synonymously with the term including and variations thereof and are open, non-limiting terms.

What is claimed:

1. A stable aqueous herbicidal composition comprising:
a. a water soluble salt of 2,4-D comprising, with respect to the total composition, from about 200 gram acid equivalent per liter (g ae/L) to about 550 g ae/L of 2,4-D;
b. a second herbicide comprising, with respect to the total composition, from about 0.1 g ae/L to about 20 g ae/L of halauxifen-methyl, from about 20 g ae/L to about 150 g ae/L of fluoroxypyr-meptyl, or a mixture thereof;
c. from about 0 g/L to about 150 g/L, with respect to the total composition, of at least one of an ionic and/or a non-ionic surfactant;
d. from about 10 g/L to about 500 g/L, with respect to the total composition, of an organic solvent; and
e. from about 200 g/L to about 800 g/L, with respect to the total composition, of water;
wherein the composition forms a stable, transparent, and homogenous herbicidal composition.

2. The herbicidal composition of claim 1, wherein the herbicidal composition shows no visible phase separation after storage at 54° C. for 2 weeks.

3. The herbicidal composition of claim 1, wherein the herbicidal composition shows no visible crystal formation at −10/40° C. freeze/thaw cycling conditions every 24 hours for 2 weeks.

4. The herbicidal composition of claim 1, wherein the water soluble salt of 2,4-D comprises one or more organo ammonium cations.

5. The herbicidal composition of any of claim 1, wherein the organo ammonium cations are dimethyl ammonium, diethyl ammonium, dimethylethanol ammonium, triethyl ammonium, diethanol ammonium, triethanol ammonium, triisopropanol ammonium, tetramethyl ammonium, choline, or mixtures thereof.

6. The herbicidal composition of claim 1, wherein the second herbicide is halauxifen-methyl and the weight ratio on an acid equivalent (ae) basis of the 2,4-D to halauxifen-methyl is from about 5500:1 to about 10:1.

7. The herbicidal composition of claim 1, wherein the second herbicide is fluoroxypyr-meptyl and the weight ratio on an ae basis of the 2,4-D to fluoroxypyr-meptyl is from about 30:1 to about 1:1.

8. The herbicidal composition of claim 1, wherein the second herbicide is a mixture of halauxifen-methyl and fluoroxypyr-meptyl.

9. The herbicidal composition of claim 1, further comprising an agriculturally acceptable adjuvant or carrier.

10. A method of controlling undesirable vegetation comprising contacting the vegetation or an area adjacent thereto to prevent the emergence of growth of vegetation a herbicidally effective amount of a herbicidal composition comprising:
a. a water soluble salt of 2,4-D comprising, with respect to the total composition, from about 200 g ae/L to about 550 g ae/L of 2,4-D;
b. a second herbicide comprising, with respect to the total composition, from about 0.1 g ae/L to about 20 g ae/L of halauxifen-methyl, from about 20 g ae/L to about 150 g ae/L of fluoroxypyr-meptyl, or a mixture thereof;
c. from about 0 g/L to about 150 g/L, with respect to the total composition, of at least one of an ionic and/or a non-ionic surfactant;
d. from about 10 g/L to about 500 g/L, with respect to the total composition, of an organic solvent; and
e. an aqueous phase comprising, with respect to the total composition, from about 200 g/L to about 800 g/L of water;
wherein the composition forms a stable, transparent, and homogenous herbicidal composition.

11. The method of claim 10, wherein the herbicidal composition shows no visible phase separation after storage at 54° C. for 2 weeks.

12. The method of claim 10, wherein the herbicidal composition shows no visible crystal formation after storage at −10/40° C. freeze/thaw cycling conditions every 24 hours for 2 weeks.

13. The method of claim 10, wherein the water soluble salt of 2,4-D comprises one or more organo ammonium cations.

14. The method of claim 10, wherein the organo ammonium cations are dimethyl ammonium, diethyl ammonium, triethyl ammonium, dimethylethanol ammonium, diethanol ammonium, triethanol ammonium, triisopropanol ammonium, tetramethyl ammonium, choline, or mixtures thereof.

15. The method of claim 10, wherein the second herbicide is halauxifen-methyl and the weight ratio on an ae basis of the 2,4-D to halauxifen-methyl is from about 5500:1 to about 10:1.

16. The method of claim 10, wherein the second herbicide is fluoroxypyr-meptyl and the weight ratio on an ae basis of the 2,4-D to fluoroxypyr-meptyl is from about 30:1 to about 1:1.

17. The method of claim 10, wherein the second herbicide is a mixture of halauxifen-methyl and fluoroxypyr-meptyl.

18. The method of claim 10, further comprising an agriculturally acceptable adjuvant or carrier.

19. The method of claim 10, wherein the undesirable vegetation is controlled in a herbicide tolerant crop.

20. The method of claim 19, wherein the herbicide tolerant crop possesses single, multiple or stacked traits conferring tolerance to one or more herbicide chemistries and/or inhibitors with single or multiple modes of action.

21. The method of claim 19, wherein the undesirable vegetation comprises a herbicide resistant or tolerant weed.
